(19) United States
(12) Patent Application Publication
(10) Pub. No.: US 2009/0200342 A1
(43) Pub. Date: Aug. 13, 2009

(54) METERED DOSAGE DISPENSER CLOSURE FOR POWDERS

(76) Inventor: Gary J. Albaum, Pleasantville, NY (US)

Correspondence Address: STITES & HARBISON PLLC, 1199 NORTH FAIRFAX STREET, SUITE 900, ALEXANDRIA, VA, 22314, US

(21) Appl. No.: 12/028,979

(22) Filed: Feb. 11, 2008

(51) Int. Cl. B67D 3/00

(52) U.S. Cl. 222/514; 222/1; 222/162; 141/353

(57) ABSTRACT

A dispenser for a container comprising an annular ring having a central portion with at least one aperture. The annular ring is attached to a valve dimensioned to close an opening of the dispenser. The valve is operatively associated with the opening and biased in the closed position. Depressing the annular ring acts as an actuator to cause the valve to move inwardly into the container and away from the opening, thereby allowing the contents to be dispensed from the container through the at least one aperture of the annular ring.

### FIELD OF THE INVENTION

The present invention relates to a dispenser and, in particular, a closure for dispensing metered dosages of a powder.

### BACKGROUND OF THE INVENTION

Powdered beverages come packaged in various containers, depending on consumer preference and use. Conventional containers for powdered beverage mixes include single serving packets, as well as bulk containers. With regard to single serving packets, a user opens a packet and pours its contents into a liquid container, such as a bottle, glass or pitcher, and then adds water to form a liquid beverage. With regard to bulk containers, a user scoops out a desired quantity of the powder and adds it to the liquid container to mix with water therein to form the liquid beverage.

One disadvantage with conventional single serving powder packets is that one is not able to easily customize the amount of powder to be added to the liquid container in order to adjust to a particular container size or a personal taste preference. Further, the single serving packet contains a predetermined amount of powder for a specific serving size, such as the required amount of powder for a 0.5 liter beverage. However, should one wish to make a beverage larger or smaller than 0.5 liters, one either has to estimate and use less than the single serving size packet when making a smaller sized beverage and use more than one packet when making a larger sized beverage. With regard to bulk powder containers, although they provide the flexibility of measuring a varying amount of powder to add to various sized liquid containers, they lack the portability and convenience that single serving packets provide.

Mechanical dispensers have to be used to dispense and meter various powders, such as laundry powder, fertilizer and medicinal powder. One recent powder dispenser is disclosed in U.S. Patent Application Publication No. 2007/0164059, which discloses a powder delivery device for dispensing a clotting agent. The dispenser comprises a housing; a plunger contained in the housing; a gating component comprising a first gate having a closed end, an open end and a second gate; and a metering area between the first gate and the second gate. The gating component permits a predetermined quantity of powdered material to be metered and dispensed.

U.S. Pat. No. 5,154,212 discloses a dispenser for metering and dispensing laundry detergent. The device includes a container with a valve assembly mounted therein. The valve assembly has a valve body including a closure member that is enlarged and conical and that closes the valve aperture of the container. The operating rod is encircled by a sealed spring that holds the valve body in position to close the valve aperture. When the spring is forced into a compressed position, e.g., by bringing the activating knob into contact with a measuring cup, the valve aperture opens and permits laundry agent within the container to flow into the measuring cup when dispensing is desired.

U.S. Pat. No. 3,232,498 discloses a dispenser for metering pre-measured quantities of material, such as tea, sugar and coffee, from a container. Dispensing of the material is controlled by a valve member which is normally biased by a spring. Force against the top of a container causes the valve member to assume a second position, permitting the material to flow into a chamber, but not out of it. Upon return of the valve to the original position, a chamber outlet is opened and the material is free to flow out of the dispenser.

U.S. Pat. No. 2,722,345 discloses a dispenser comprising a container body holding a granular product, a measuring chamber below the container body, and a valve between a container body and the measuring chamber, biased in an open position to allow product to flow into the measuring chamber. The valve selectively opens and closes two passages into and out of the measuring chamber. In its initial position, the valve is biased to open the passage between the container body and the measuring chamber and to close the passage between the measuring chamber and the exterior. Inversion of the dispenser causes a granular product to flow from the container body into the measuring chamber. While inverted, depressing a rod (actuator) attached to the valve closes the opening between the measuring chamber and the container body, preventing additional granular product from flowing into the measuring chamber from the container body from above, and simultaneously opens the passage from the measuring chamber to the exterior, permitting the product in the measuring chamber to be dispensed from the dispenser.

There is a need in the powdered beverage dispensing art for new and improved dispensers for dispensing and metering powdered beverages.

### SUMMARY OF THE INVENTION

The present invention relates to a new and improved dispenser for dispensing metered dosages of a powder, such as a powdered beverage. The dispenser is designed to allow a user to controllingly dispense a desired quantity of powder into a liquid container, such as a glass, bottle or pitcher. Advantageously, the dispenser is of a small enough diameter, i.e. “palm sized,” to allow one to easily store the dispenser in one's pocket, bag or the like. The dispenser comprises a valve and an actuator attached to the valve which biases the valve in a closed position. The actuator has a center opening. Powder is dispensed from the dispenser by inverting the dispenser and resting the actuator on a rim of a liquid container, such as a glass, bottle or pitcher, with the valve in its biased, closed position over the actuator opening, thus preventing powder from exiting the dispenser. With the actuator opening over the mouth of the liquid container, pressing downward on the actuator moves the valve away from the opening, thereby opening the valve and allowing powder to flow continuously from the dispenser through the actuator opening and into the liquid container disposed below. Metering of the amount of powder dispensed is provided by counting or timing how long the powder is being dispensed (the “flow time”) and correlating a known flow rate with the flow time to calculate how much powder has been dispensed. Thus, one can meter a precise amount of powder by dispensing the powder for a predetermined amount of time. Further, one can precisely vary the amount of powder dispensed by dispensing the powder for various preset flow times which correspond with various predetermined powder amounts.

The present invention, in one form thereof, relates to a dispensing device for a container. The dispensing device comprises an opening of the container and an annular ring having a central portion with at least one aperture. The annular ring is attached to a valve dimensioned to close the opening. The valve has a top surface and a side surface; and is operatively associated with the opening and biased in a closed position. Depressing the annular ring causes the valve to move inward, into the container and away from the opening, thereby allowing the contents to be dispensed from the container in a continuous flow, over the top surface of the valve, and through the at least one aperture of the annular ring when the dispenser is inverted.

In one advantageous form, the opening of the container is formed by a mouth of the container and the annular ring surrounds the opening, wherein when the annular ring is depressed inwardly, the annular ring slides down around the mouth of the container, thereby exposing the mouth of the container. The mouth of the container may comprise a pair of channels and the annular ring may comprise a transverse member spanning the central portion of the annular ring, wherein the transverse member is disposed in the pair of channels of the mouth of the container.

In another advantageous form, the annular ring has an exterior wall with a surface abutting an interior facing surface of the container, forming a bearing surface therebetween.

The present invention, in another form thereof, relates to a dispensing container which comprises a container body having an opening at its top and an annular ring surrounding the opening. A plug is disposed in and closes the opening. The plug has a top surface and a side surface. The plug is attached to the annular ring and is biased in a closed position. Depressing the annular ring moves the valve inwardly towards a center of the container, thereby moving the plug away from the opening, allowing the contents of the container to be dispensed in a continuous flow, over the top surface of the plug, through the opening and out through a center portion of the annular ring.

Advantageously, the container is dimensioned to be easily grasped and held in one's hand. For example, the container may have dimensions of one to ten inches in height and a width and depth of one to four inches.

The present invention, in another form thereof, relates to a method for dispensing contents from a container. The method comprises inverting a dispenser having a depressible actuator attached to a valve which closes an opening, pressing the actuator on a surface to open the valve, thereby starting the flow of the contents from the container through the opening, and metering the amount of contents from the dispenser, based on knowing the flow rate of the contents from the container.

In one specific form, metering the amount dispensed comprises timing how long the contents are dispensed from the container and correlating the time to how much of the contents are dispensed, based on a known flow rate.

In one advantageous form, the method comprises pressing the actuator, in the form of an annular ring with center bore, on the mouth of a liquid container therebelow, with the center bore over the liquid container, so that the contents will flow from the dispenser through the center bore of the annular ring and into the liquid container below.

### BRIEF DESCRIPTION OF THE FIGURES

FIG. 1a is a side elevational view of a container with dispensing closure with a cap over the dispensing closure, in accordance with the present invention;

FIG. 1b is the container of FIG. 1a with the cap, shown in its open position;

FIG. 2a is a cross-sectional view of the container of FIG. 1b inverted 180° and taken along line 2a,b-2a,b of FIG. 1b, shown in a closed configuration, in accordance with the present invention;

FIG. 2b is a cross-sectional view of the container of FIG. 1b, inverted 180° and shown with a valve in an open position, in accordance with the present invention;

FIG. 3 is an exploded view of the dispensing closure of FIGS. 2a and 2b;

FIG. 4 is a plan view of a base of a closure of the container of FIGS. 2a and 2b, viewed from below;

FIG. 5 is a plan view of the base of the closure of FIGS. 2a and 2b, viewed from above;

FIG. 6 is a plan view of an annular ring and valve of the dispensing closure, shown in FIGS. 2a and 2b, viewed from below;

FIG. 7 is the annular ring and valve of FIGS. 2a and 2b, viewed from above;

FIG. 8 is a plan view of the container of FIG. 1b;

FIG. 9a is a partial cross-section of the container of FIGS. 2a and 2b, shown in the closed position over a drinking bottle, in accordance with the present invention;

FIG. 9b is a partial cross-section of the container and bottle of FIG. 9a, shown in the opened position, in accordance with the present invention; and

FIG. 10 is a partial cross-section of the container of FIG. 1b, shown in an open position over a liquid container, in accordance with the present invention.

### DETAILED DESCRIPTION

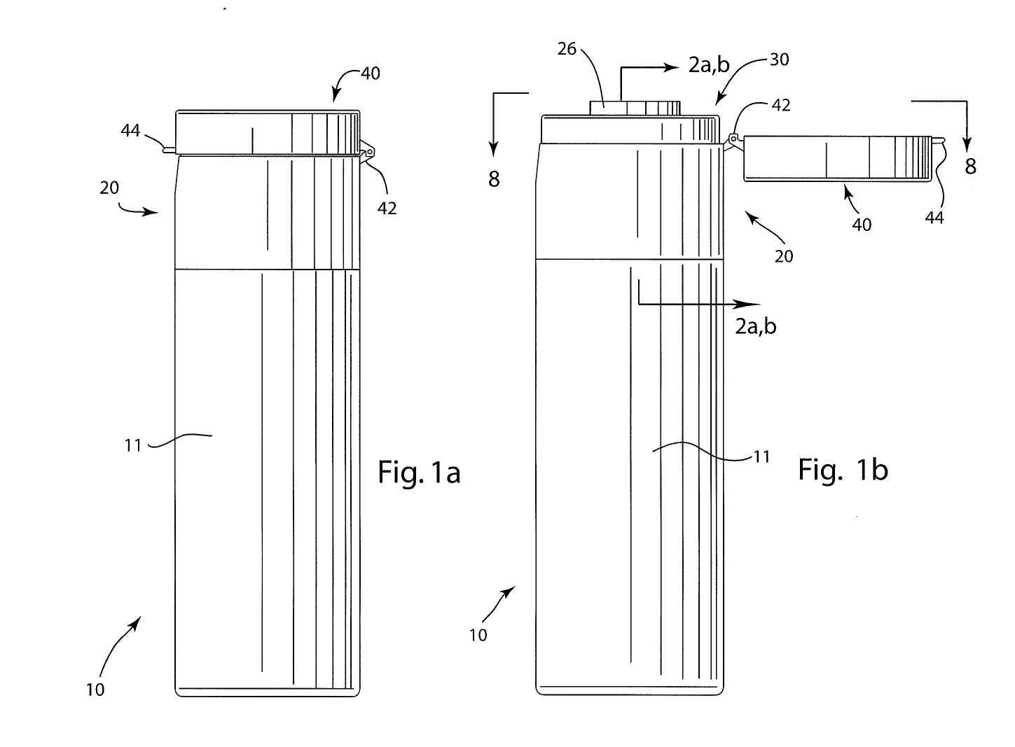

Referring now to the drawings and, in particular, FIGS. 1a and 1b, container 10 comprises container body 11, closure 20 and cap 40. Cap 40 is pivotally attached to the closure 20 via hinge 42. A tab 44 is disposed on the cap 40 which allows one to easily grasp the cap 40 to move the cap 40 away from the top of the closure 20, as shown in FIG. 1b. The cap 40 preferably provides a primary moisture seal for the contents of container 10.

Advantageously, container 10 has a height of one to ten inches and a diameter of one to four inches. In alternative forms, if the container is not in the form of a cylindrical body, the width and depth of the container ranges from one to four inches.

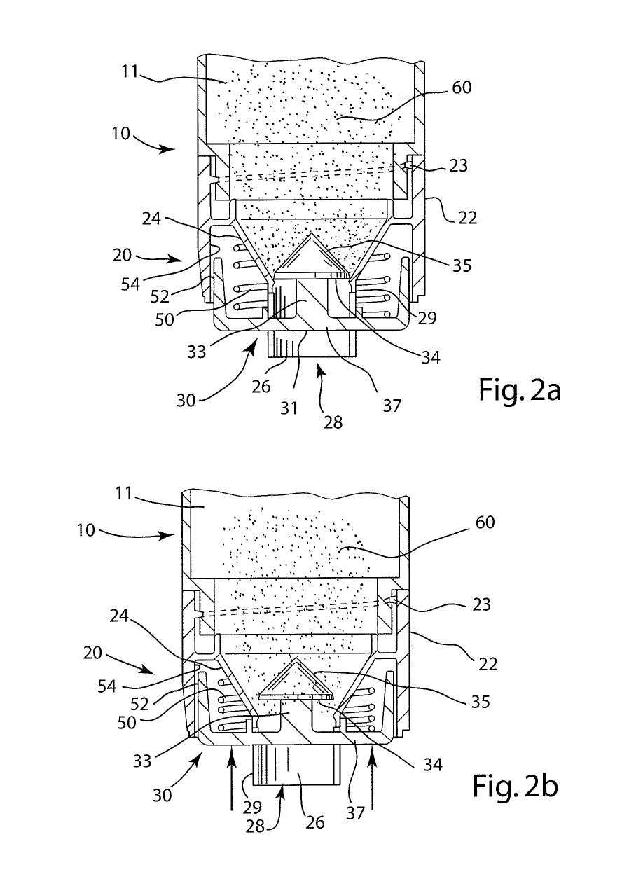

Referring now to FIGS. 2-5, closure 20 comprises a base 22, which includes threads 23 which engage with complementary threads (not shown) at the top of container body 11. The base 22 has an angled or conically-shaped wall 24 which leads to a spout 26 having a central bore terminating at an opening 28. A pair of channels 29 extend longitudinally from the opening 28 to approximately where the spout 26 meets the conical portion 24. Base 22 has an interior facing surface 54, facing spout 26.

Although base 22 of closure 20 is depicted as an independent component from the container body 11, alternatively, the base 22 may be integrally formed with, and a part of, the container body 11, and thus not a separate component threadingly engaged with the container body 11. Further, the dispensing closure 20 can be disposed on container bodies having shapes other than cylindrical forms.

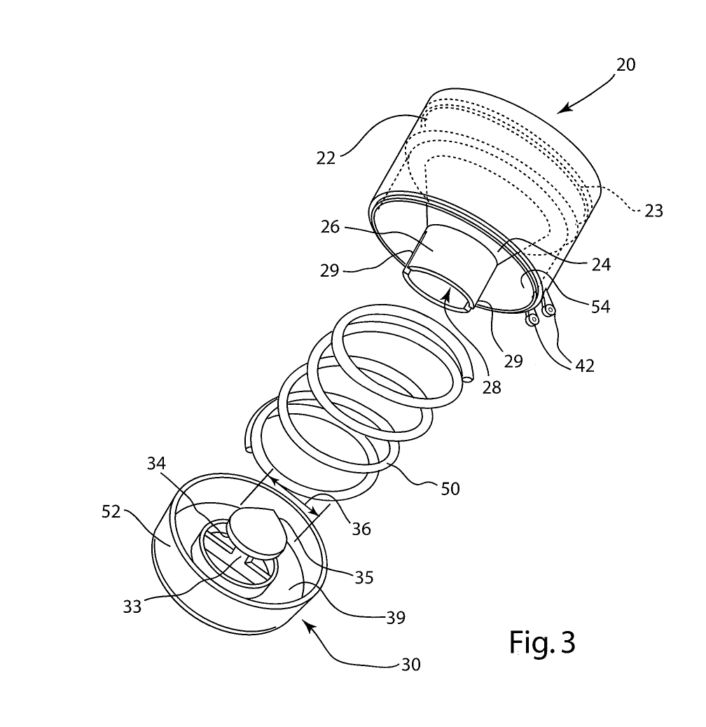

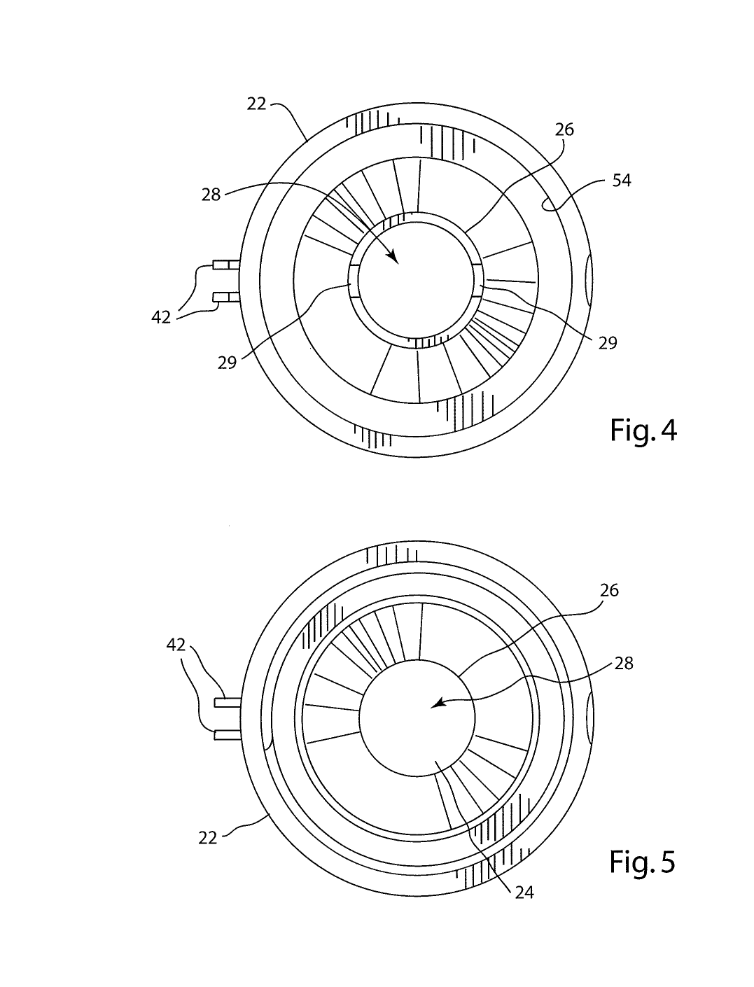

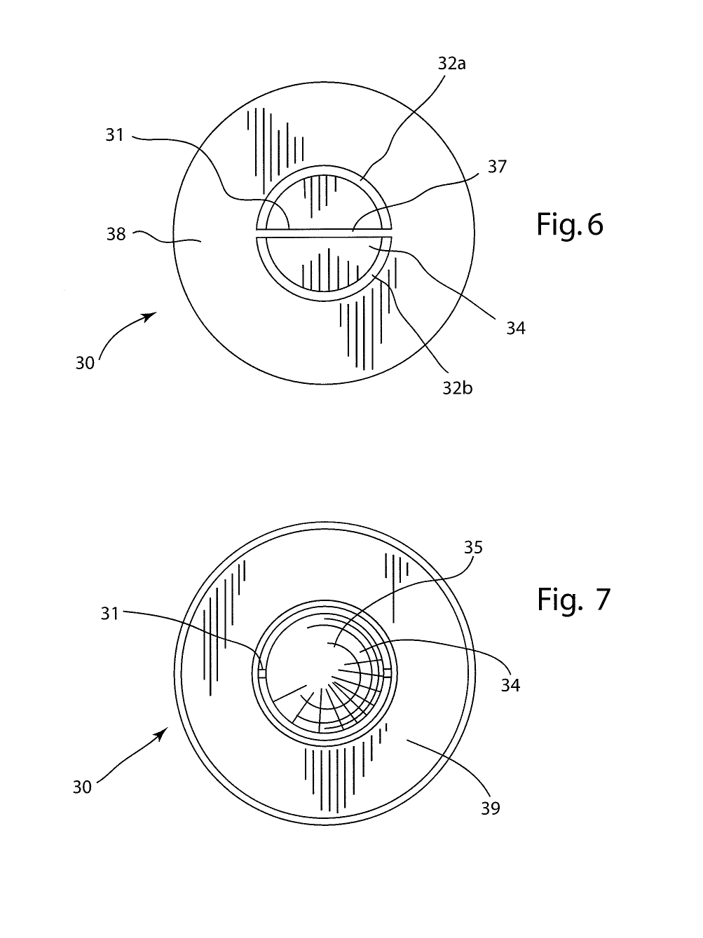

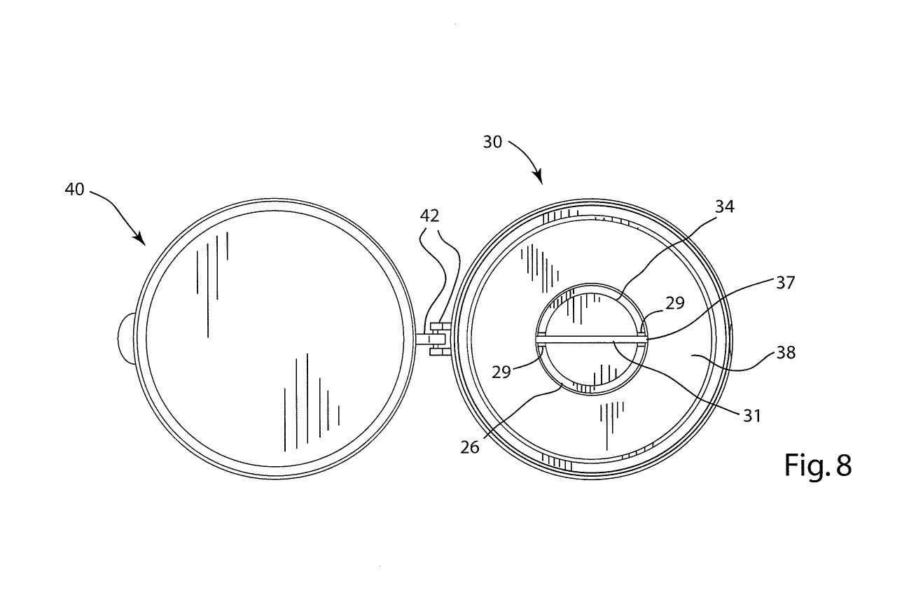

Referring now to FIGS. 6 and 7, along with FIG. 3, the closure 20 comprises an annular ring 30. The annular ring 30 comprises a transverse member 31 which divides the annular ring aperture into apertures 32a and 32b. Outwardly facing surface 37 of bar 31 is flush with exterior facing surface 38 which forms the top of annular ring 30. Member 33 extends from the transverse member 31 to a valve in the form of plug 34. Plug 34 has an angled or conical surface 35. The widest portion of plug 34 has a width 36 which is slightly larger than the diameter of spout 26 so that the plug 34 can be press fit through spout 26.

A spring 50 is disposed between the annular ring 30 and the base 22 of the closure 20. Specifically, the spring 50 is in contact with uppermost inner facing surface 39 of the wall of the annular ring 30. In its assembled form, the annular ring 30 fits over and is disposed around the spout 26 with the plug 34 disposed in the bore formed by spout 26 and spout 26 extending up from a top surface of annular ring 30. The spring 50 biases the annular ring 30 so as to force the plug 34 to its closed position, completely closing the opening 28. The transverse member 31 is disposed in the pair of channels 29 and slides within the channels 29 when the annular ring 30 is depressed inward towards the base 22 against the biasing force of spring 50.

Advantageously, exterior wall surface 52 of annular ring 30 abuts interior facing wall surface 54 of base 22, forming a bearing surface therebetween. The bearing surface between the annular ring 30 and the base 22 resists rotation of the annular ring 30 about any horizontal axis relative to the base 22.

Referring now to FIGS. 2a and 2b, which depict closure 20 in its closed position, spring 50 biases the annular ring 30 to force the plug 34 to completely cover the entrance to the spout 26. As a result, the contents 60, in the form of a powder, are prevented from entering the spout 26, and thus prevented from exiting the opening 28.

The annular ring 30 acts as an actuator, whereby pressing the annular ring 30 inward towards the container body 11 forces the plug 34 inward and away from the entrance to spout 26, as shown by the arrows in FIG. 2b. As a result, powder 60 can enter spout 26 and exit out of opening 28 and on through annular apertures 32a, 32b.

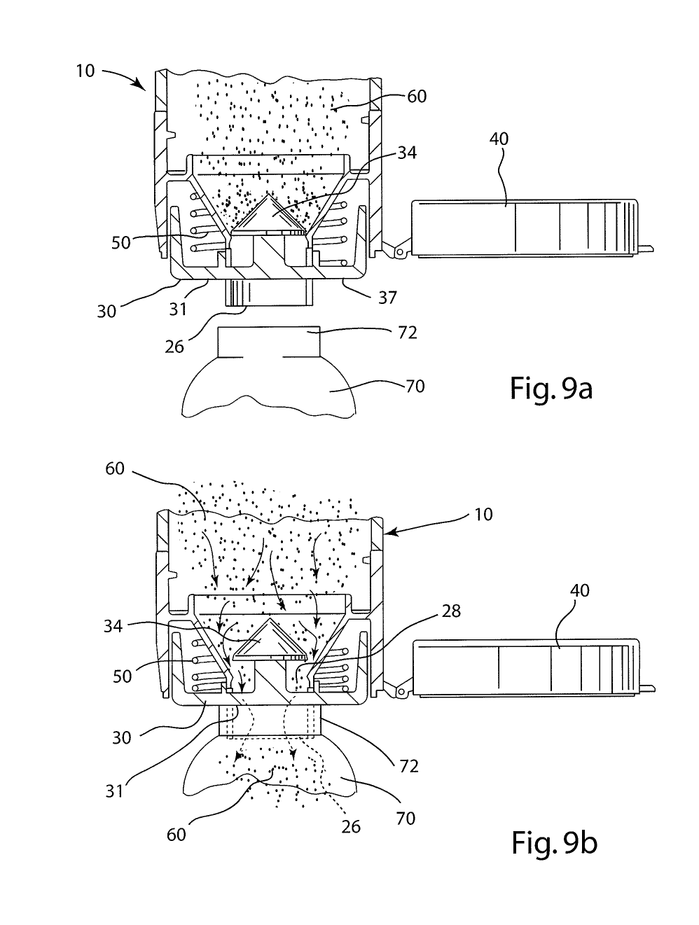

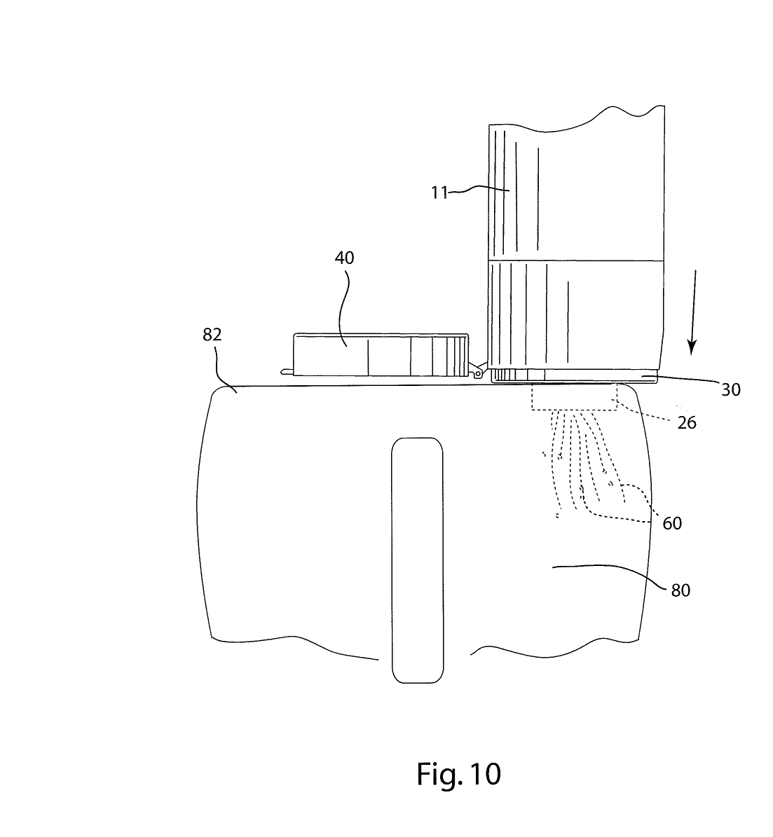

Referring now to FIGS. 9a and 9b, the container 10 can be used to dispense a powder 60, which is disposed in the container body 11, to a liquid container, such as a drinking bottle 70. First, a user inverts the container 10 so that the annular ring 30 is facing downward over the mouth of the bottle 70 disposed therebelow. Subsequently, the user rests the annular ring 30 over the mouth 72 with the annular apertures 32a, 32b completely over the mouth 72 with the spout 26 extending into the bottle 70. Having the spout 26 extend from a top surface of the annular ring 30 helps ensure that the opening of the container 10 will be completely over the mouth of the bottle 70 when dispensing the powder 60. Subsequently, the user presses downward on the container 10, thereby pressing the annular ring 30 inward towards the center of container 10, and thereby actuating the plug 34 to move inwardly towards the container body 11, as shown in FIG. 9b. Consequently, the plug 34 is moved inwardly away from the entrance of spout 26. As a result, powder 60 is able to flow continuously from container body 11, over the top and around the annular angled surface 35 of plug 34, along the angled surface of wall 24, into spout 26, out opening 28, on through the annular apertures 32a, 32b and into the bottle 70 disposed therebelow. Withdrawing the container 10 from bottle 70 results in the annular ring 30 with plug 34 being forced back to its original position due to the biasing force of spring 50, thereby closing the opening 28 by returning to its original closed position at the entrance of spout 26, as shown in FIGS. 2a and 9a. As a result, powder 60 can no longer flow from container body 11 and out opening 28. Therefore, one can now remove the container 10 from the top of the bottle 70 without additional powder 60 flowing from the container 10.

Referring now to FIG. 10, container 10 can be used to dispense a powder into other liquid containers, such as glass 80. In order to dispense powder 60 into glass 80, first, one inverts container 10 and rests the annular ring 30 on the mouth 82. Subsequently, the user presses downward on the container 10, thereby forcing the annular ring 30 inward towards the center of container 10, thereby moving plug 34 inward and allowing the flow of powder 60 from the container body 11, through apertures 32a, 32b and into glass 80, as shown in FIG. 10. Since the apertures 32a, 32b are completely over the mouth 82, all of the powder 60 dispensed will go directly into the glass 80 disposed therebelow. As noted, having spout 26 extend from the annular ring 30 helps ensure that apertures 32a, 32b are completely over the mouth 82.

It will now be apparent to one of ordinary skill in the art that container 10 can be used to dispense a powder into an appropriate liquid container, including different sizes of glasses, bottles and pitchers.

The present closure 20 can be used to meter the amount of powder which is dispensed. By knowing the flow rate (the amount of time it takes for a predetermined amount of powder to be dispensed through the opening), one can meter the amount of powder that is dispensed by timing how long the powder is dispensed. Using the flow rate, one can dispense the powder for a predetermined amount of time which is correlated to a desired quantity. For example, a flow time of two seconds may be correlated to the amount of powder needed for a 0.5 liter beverage and a flow time of four seconds may be correlated to the amount of powder needed for a 1 liter beverage.

It will now be clear to one of ordinary skill in the art that the present dispenser has features and advantages over prior dispensers for powdered beverages. The present invention allows for controlled dispensing of a powder into a bottle without spilling the powder, since the powder can only be dispensed when the container is over the mouth of a bottle and the container is depressed to start the flow of the powder. The flow stops when the container is removed from the top of the bottle. In addition, the present dispenser allows for metering a controlled amount of powder which is dispensed by knowing the flow rate and timing how long the powder is dispensed into a bottle or other vessel disposed below. As a result, the present dispenser dispenses a desired amount of powdered beverage depending on the vessel, e.g., bottle, glass or pitcher to which the powder is being dispensed. Consequently, the present container can be used to dispense the exact amount of powder that is needed into whatever size vessel one wishes.

Although the invention has been described above in relation to preferred embodiments thereof, it will be understood by those skilled in the art that variations and modifications can be effected in these preferred embodiments without departing from the scope and spirit of the invention.

1. A dispensing device for a container, said dispensing device comprising:
an opening of the container;
an annular ring having a central portion with at least one aperture, the annular ring attached to a valve dimensioned to close the opening, said valve having a top surface and a side surface, said valve operatively associated with the opening and biased in a closed position,
wherein depressing the annular ring causes the valve to move inwardly, into the container and away from the opening, thereby allowing a continuous flow of the contents to be dispensed from the container, flowing over the top surface of the value, and through the at least one aperture of the annular ring.

2. The dispensing device of claim 1, further comprising a transverse member spanning the central portion of the annular ring, thereby defining two apertures of the at least one aperture, the valve attached to a transverse member.

3. The dispensing device of claim 2, further comprising a stop which limits how far the transverse member can travel.

4. The dispensing device of claim 2, wherein the transverse member has an outwardly facing surface which is flush with an outward facing surface of the annular ring.

5. The dispensing device of claim 1, wherein the opening of the container is formed by a mouth of the container and the annular ring surrounds the opening, wherein when the annular ring is depressed inwardly, the annular ring slides down around the mouth of the container, thereby exposing the mouth of the container.

6. The dispensing device of claim 5, wherein the mouth of the container comprises a pair of channels and the annular ring comprises a transverse member spanning the central portion of the annular ring, wherein the transverse member is disposed in the pair of channels of the mouth of the container.

7. The dispensing device of claim 1, further comprising an inwardly angled wall which defines the opening of the container.

8. The dispensing device of claim 1, further comprising a removable cap disposed on the annular ring, thereby preventing the annular ring from being depressed.

9. The dispensing device of claim 1, further comprising a removable cap which provides a moisture seal over the opening of the container to thereby protect contents of the container from moisture.

10. The dispensing device of claim 1, wherein the annular ring has an exterior wall with surface abutting an interior facing surface of the container, forming a bearing surface therebetween.

11. The dispensing device of claim 1, wherein the valve is biased in the closed position by a spring, the spring in contact with an uppermost inner facing surface of a wall of the annular ring, said wall having an exterior facing surface which forms a flush, uppermost top surface of the annular ring.

12. The dispensing device of claim 11, further comprising a transverse member spanning the central portion of the annular ring, thereby defining two apertures of the at least one aperture, the valve attached to a transverse member.

13. The dispensing device of claim 12, wherein the transverse member has an outwardly facing surface which is flush with the top surface of the annular ring.

14. The dispensing device of claim 1, wherein the opening of the container comprises a spout which extends up through the annular ring when the valve is in both the closed position and the open position.

15. A dispensing container, said container comprising:
a container body having an opening at its top;
an annular ring surrounding the opening; and
a plug disposed in and closing the opening which is attached to the annular ring, said plug valve biased in a closed position, the plug having a top surface and a side surface,
wherein depressing the annular ring moves the plug inwardly towards a center of the container, thereby moving the plug away from the opening and allowing the contents to be dispensed from the container in a continuous flow over the plug, through the opening and out through a center portion of the annular ring.

16. The dispensing container of claim 15, further comprising an inwardly angled wall which defines the opening of the container.

17. The dispensing container of claim 15, further comprising a transverse member spanning the central portion of the annular ring, the plug attached to a transverse member.

18. The dispensing container of claim 17, further comprising a stop which limits how far the transverse member can travel.

19. The dispensing container of claim 17, wherein the transverse member has an outwardly facing surface which is flush with an outward facing surface of the annular ring.

20. The dispensing container of claim 15, further comprising a removable cap disposed on the annular ring, thereby preventing the annular ring from being depressed.

21. The dispensing container of claim 15, wherein the annular ring has an exterior wall with surface abutting an interior facing surface of the container, forming a bearing surface therebetween.

22. The dispensing container of claim 15, wherein the valve is biased in the closed position by a spring, the spring in contact with an uppermost inner facing surface of a wall of the annular ring, said wall having an exterior facing surface which forms a flush, uppermost top surface of the annular ring.

23. The dispensing container of claim 22, further comprising further comprising a transverse member spanning the central portion of the annular ring, thereby defining two apertures of the at least one aperture, the valve attached to a transverse member.

24. The dispensing container of claim 23, wherein the transverse member has an outwardly facing surface which is flush with the top surface of the annular ring.

25. The dispensing container of claim 15, further comprising flowable powder contents disposed in the container body.

26. The dispensing container of claim 25, wherein the flowable powder is a powdered drink mix.

27. The dispensing container of claim 15, wherein the container body is handheld, palm size.

28. The dispensing container of claim 27, wherein the container body is in the shape of a cylinder.

29. The dispensing container of claim 15, wherein the container has dimensions of one to ten inches in height and one to four inches in width and depth.

30. The dispensing container of claim 15, wherein the plug is the same size as the opening which it closes, so that the plug is slightly larger than the opening, to thereby prevent contents of the container from being dispensed when the container is in a closed position.

31. The dispensing container of claim 15, wherein the opening of the container is formed by a mouth of the container, and the annular ring surrounds the opening, wherein when the annular ring is depressed inwardly, the annular ring slides down around the mouth of the container, thereby exposing the mouth of the container.

32. The dispensing container of claim 31, wherein the mouth of the container comprises a pair of channels and the annular ring comprises a transverse member spanning the central portion of the annular ring, wherein the transverse member is disposed in the pair of channels of the mouth of the container.

33. The dispensing container of claim 15, wherein the opening comprises a spout extending from the container body up through the annular ring such that the spout extends up from a top surface of the annular ring when the plug is in both the closed position and the open position.

34. A method for dispensing contents from a container, said method comprising,
inverting a dispenser having a depressible actuator attached to a valve closing an opening;
pressing the actuator on a surface to open the valve, thereby starting the flow of the contents from the container through the opening; and
metering the amount of the contents dispensed from the dispenser based on knowing the flow rate of the contents from the container.

35. The method of claim 34, wherein said metering comprises timing how long the contents are dispensed from the container and correlating the time with the quantity of the contents dispensed.

36. The method of claim 34, wherein pressing the actuator on a surface comprising pressing the actuator, in the form of an annular ring with center bore on the mouth of a vessel, with the center bore over the vessel, so that the contents flow from the dispenser through the center bore of the annular ring and into the vessel below.

37. The method of claim 34, wherein inverting a dispenser comprises inverting a dispenser having a spout extending up from a top surface of the actuator and placing the dispenser over the mouth of a liquid vessel, so that the spout extends into the vessel.
